(19) United States
(12) Patent Application Publication
(10) Pub. No.: US 2018/0343473 A1
(43) Pub. Date: Nov. 29, 2018

(54) METHOD FOR PROVIDING CONTENT SERVICE AND SYSTEM THEREOF

(71) Applicant: ROLabs Inc., Siheung-si (KR)

(72) Inventors: Won Suk Jeong, lncheon (KR); Jin Hun Kim, Seoul (KR); Kwang Yong Choi, Seongnam-si, (KR)

(21) Appl. No.: 15/986,805

(22) Filed: May 22, 2018

(30) Foreign Application Priority Data
May 26, 2017 (KR) 10-2017-0065032
Dec. 18, 2017 (KR) 10-2017-0174082

(51) Int. Cl. H04N 21/2187; H04N 21/236; H04N 21/231

(52) U.S. Cl. CPC H04N 21/2187; H04N 21/231; H04N 21/236

(57) ABSTRACT

A method for providing a content service using a content acquisition apparatus, a server, and a content execution apparatus includes generating video data using a camera of the content acquisition apparatus, generating motion data by measuring an angular velocity and acceleration of the content acquisition apparatus using sensors of the content acquisition apparatus, and generating content by synchronizing the video data with the motion data, reading, by the server, a first set signal from a memory, receiving, by the server, the content transmitted from the content acquisition apparatus and storing the content in a database when the first set signal indicates VOD streaming, and receiving, by the server, the content transmitted from the content acquisition apparatus and live streaming the content to the content execution apparatus when the first set signal indicates live streaming.

This application claims priority under 35 U.S.C. § 119 to Korean Patent Application No. 10-2017-0065032, filed on May 26, 2017 and 10-2017-0174082 filed on Dec. 18, 2017 in the Korean Intellectual Property Office, the disclosures of which are incorporated by reference herein in its entirety.

### TECHNICAL FIELD

Embodiments of the present inventive concept relate to a method for providing a content service, and particularly, to a method of storing content generated by a content acquisition apparatus in a database for video-on-demand (VOD) streaming or live streaming the content to a content execution apparatus according to settings of a user, and a system thereof.

### BACKGROUND ART

Currently, content in a virtual space is delivered by human visual and auditory information. Current IT-based portable devices support various types of content through development of three-dimensional graphic technology and virtual reality technology.

### SUMMARY OF INVENTION

An object of the present inventive concept is to provide a method of storing content generated by a content acquisition apparatus in a database for VOD streaming or live streaming the content to a content execution apparatus in accordance with settings of a user, and a system thereof.

The object of the present inventive concept is to provide a method of controlling (or adjusting), by a user of a content acquisition apparatus and/or a user of the content execution apparatus, at least one of components included in the content acquisition apparatus, and a system thereof.

According to an exemplary embodiment of the present inventive concepts, a method for providing a content service using a content acquisition apparatus, a server, and a content execution apparatus includes generating video data using a camera of the content acquisition apparatus, generating motion data by measuring an angular velocity and acceleration of the content acquisition apparatus using sensors of the content acquisition apparatus, generating content by synchronizing the video data with the motion data, reading, by the server, a first set signal from a memory, receiving, by the server, the content transmitted from the content acquisition apparatus and storing the content in a database when the first set signal indicates VOD streaming, receiving, by the server, the content transmitted from the content acquisition apparatus and live streaming the content to the content execution apparatus when the first set signal indicates live streaming, separating, by the content execution apparatus, the video data and the motion data from the content to be live streamed, transmitting the video data to a head mounted device (HMD), and transmitting the motion data to a motion simulator to control the motion of the motion simulator.

According to another exemplary embodiment of the present inventive concepts, a method for providing a content service using a content acquisition apparatus, a server, and a content execution apparatus includes setting a content transmission mode using the content acquisition apparatus, generating video data using a camera of the content acquisition apparatus, generating motion data by measuring an angular velocity and acceleration of the content acquisition apparatus using sensors of the content acquisition apparatus, generating content which includes mode information including the content transmission mode, the video data, and the motion data, receiving, by the server, the content transmitted from the content acquisition apparatus, determining, by the server, the mode information, receiving and storing, by the server, the content in a database when the mode information indicates VOD streaming, bypassing and live streaming, by the server, the content to the content execution apparatus when the mode information indicates live streaming, separating, by the content execution apparatus, the video data and the motion data from the content to be live streamed, transmitting the video data to a head mounted device (HMD), and transmitting the motion data to a motion simulator to control the motion of the motion simulator.

### BRIEF DESCRIPTION OF DRAWINGS

FIG. 1 is a block diagram of a data providing service system according to exemplary embodiments of the present inventive concepts;

FIG. 2 is an exemplary embodiment of a method of setting a content disclosure status, a content transmission mode, and an authorized user;

FIG. 3 is a data flow for describing an operation of the data providing service system shown in FIG. 1;

FIG. 4 is a data flow for describing an operation of the data providing service system shown in FIG. 1; and

FIG. 5 is a data flow for describing an operation of the data providing service system shown in FIG. 1.

### DETAILED DESCRIPTION OF THE INVENTION

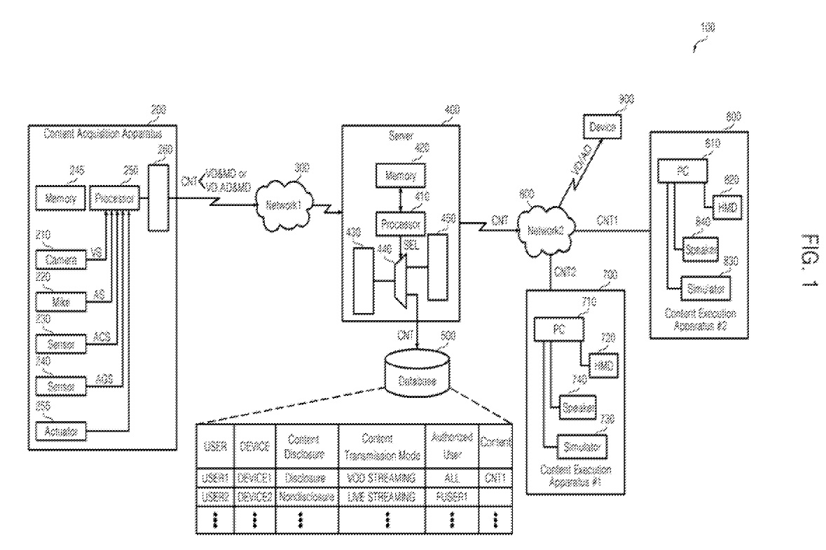

FIG. 1 is a block diagram of a data providing service system according to an exemplary embodiment of the present invention. Referring to FIG. 1, a data (2D content or 3D content) providing service system 100 includes a content acquisition apparatus 200, a server 400, a database 500, and a plurality of content execution apparatuses 700 and 800. According to exemplary embodiments, the data providing service system 100 may further include a device 900. The device 900, for example, a smart phone, may refer to a device including a display and/or a speaker.

The data providing service system 100 may be embodied as a virtual reality service system capable of providing a virtual reality (VR) service, an experience service providing system capable of providing a VR service, or a remote control system capable of providing a VR service, but a technical concept of the present invention is not limited thereto.

The content acquisition apparatus (or device) 200 may collectively refer to a device capable of acquiring various types of data (or various types of content), and may also be embodied as a smart phone, a wearable computer, an Internet of Things (IoT) device, a drone, a camcorder, an action camera or an action-cam, a sports action camcorder, an automobile, or the like. In the present specification, content or contents may include video signals, audio signals, and/or motion signals. For example, the motion signals include acceleration and an angular velocity. Signals may refer to analog signals or digital signals.

The content acquisition apparatus 200 may include a camera 210, a mike, an acceleration sensor 230, an angular velocity sensor 240, a memory 245, a processor 250, an actuator 255, and a radio (or wireless) transceiver 260.

The camera 210 may generate video signals VS such as still images or moving images, and output the video signals VS to the processor 250. The camera 210 may be embodied as a Complementary Metal Oxide Semiconductor (CMOS) image sensor. The camera 210 may be embodied as a CMOS image sensor capable of generating color information and depth information. The camera 210 may be embodied as at least one camera capable of generating video signals VS such as three-dimensional (3D) images or stereoscopic images.

The operation of the camera 210, for example, a recording or photographing direction, may be controlled by the processor 250 processing a control signal generated in the content acquisition apparatus 200 by a user's operation of the content acquisition apparatus 200 or a control signal generated in the content execution apparatus 700 or 800 by a user's operation of the content execution apparatus 700 or 800.

The mike 220 may also be referred to as a microphone, and may generate audio signals AS and output the audio signals AS to the processor 250. According to exemplary embodiments, the mike 220 may or may not be disposed (or installed) in the content acquisition apparatus 200.

For example, the operation, for example, ON or OFF, of the mike 220 may be controlled by the processor 250 processing a control signal generated in the content acquisition apparatus 200 by a user's operation of the content acquisition apparatus 200 or a control signal generated in the content execution apparatus 700 or 800 by a user's operation of the content execution apparatus 700 or 800.

The acceleration sensor 230 is a device for measuring acceleration ACS of the content acquisition apparatus 200, and acquires a velocity (or velocity information) by integrating acceleration ACS one time with respect to time and acquires displacement (or displacement information) by integrating the velocity once more with respect to time. A three (3)-axis acceleration sensor may be used as the acceleration sensor 230, but the present invention is not limited thereto.

For example, the operation, for example, ON or OFF, of the acceleration sensor 230 may be controlled by the processor 250 processing a control signal generated in the content acquisition apparatus 200 by a user's operation of the content acquisition apparatus 200 or a control signal generated in the content execution apparatus 700 or 800 by a user's operation of the content execution apparatus 700 or 800.

The angular velocity sensor 240 is a device for measuring angular velocity AGS of the content acquisition apparatus 200, acquires an angle (or angle information) by integrating the angular velocity one time with respect to time, acquires angular acceleration by differentiating the angular velocity with respect to time, and acquires rotatory power or torque by combining each acceleration with the moment of inertia. The angular velocity sensor 240 may be embodied as a gyro sensor, but the present invention is not limited thereto. The motion signals (or motion data) are signals (or data) related to acceleration ACS and an angular velocity AGS.

For example, the operation (for example, ON or OFF) of the angular velocity sensor 240 may be controlled by the processor 250 processing a control signal generated in the content acquisition apparatus 200 by a user's operation of the content acquisition apparatus 200 or a control signal generated in the content execution apparatus 700 or 800 by a user's operation of the content execution apparatus 700 or 800.

Even if the acceleration sensor 230 and the angular velocity sensor 240 are exemplarily shown as separate sensors in FIG. 1, the acceleration sensor 230 and the angular velocity sensor 240 may be embodied as one hardware chip or hardware module.

The memory 245 may store data and/or firmware (or application programs) for the operation of the content acquisition apparatus 200. The memory 245 collectively refers to a volatile memory such as a dynamic random access memory (DRAM) and a non-volatile memory such as a flash memory.

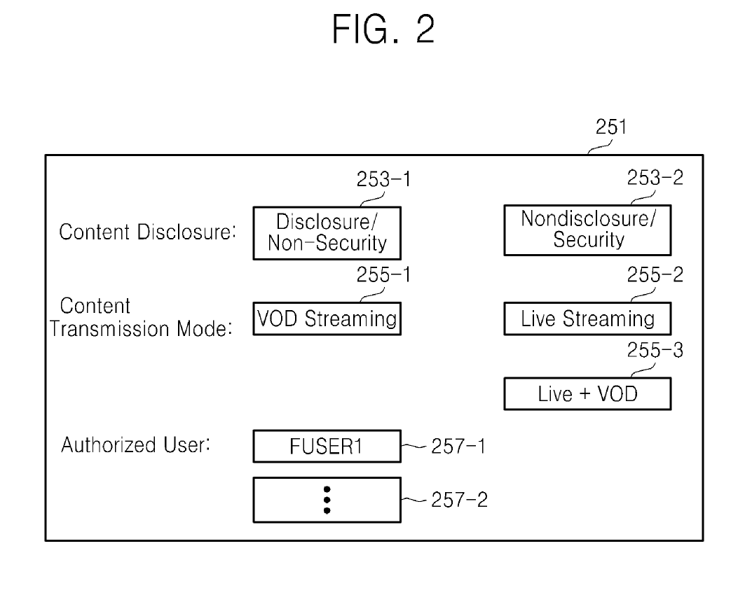

For example, as shown in FIG. 2, a user of the content acquisition apparatus 200 may set “content disclosure”, “content transmission mode,” and “authorized (or allowed) user” using the firmware (or application programs) stored in the memory 245. According to exemplary embodiments, “content disclosure,” “content transmission mode,” and “authorized user” may be set using a smart phone capable of wirelessly communicating with the content acquisition apparatus 200.

The memory (or memory device) 245 may store a control policy, for example, information or data indicating which control signal to process first between a control signal generated in the content acquisition apparatus 200 by a user's operation of the content acquisition apparatus 200 and a control signal generated in the content execution apparatus 700 or 800 by a user's operation of the content execution apparatus 700 or 800.

The processor 250 may control an operation of each component 210, 220, 230, 240, 245, 255, and 260 and execute an operating system (OS) and firmware (or application programs) stored in the memory 245. The processor 250 may refer to a central processing unit (CPU), a micro control unit (MCU), a graphics processing unit (GPU), a general-purpose computing on graphics processing units (GPGPU), or an application processor (AP).

The processor 250 may generate synchronized signals by synchronizing video signals (VS) with motion signals. In addition, the processor 250 may generate synchronized signals by synchronizing video signals VS, audio signals AS, and motion signals with one another.

For example, the processor 250 may generate a synchronized packet by synchronizing video signals VS with motion signals (or video signals VS, audio signals AS, and motion signals) on a frame-by-frame basis, and transmit the synchronized packet to the server 400 through a first communication network 300. The processor 250 may generate a synchronized packet including synchronization information.

The synchronized packet may include video data VD related to video signals VS and motion data MD related to motion signals. Moreover, the synchronized packet may include video data VD related to video signals VS, audio data AD related to audio signals AS, and motion data MD related to motion signals. The synchronized packet may refer to content or contents CNT.

As another example, the processor 250 may generate signals or packets including video signals VS and motion signals (or video signals VS, audio signals AS, and motion signals) by inserting a timestamp into a layer into which metadata of video signals VS can be inserted.

That is, the content acquisition apparatus 200 may generate content (or contents) CNT including video data VD and motion data MD synchronized with each other in time, or content(s) CNT including video data VD, audio data AD, and motion data MD, and transmit content(s) CNT including synchronization information to the server 400 through the first communication network 300.

The actuator 255 collectively refers to a device which gives motion to an object included in the content acquisition apparatus 200 under control of the processor 250. For example, the actuator 255 may be embodied as an electric actuator such as a DC motor (or an AC motor), a hydraulic actuator such as a hydraulic cylinder or a hydraulic motor, and/or a pneumatic actuator such as a pneumatic cylinder or a pneumatic motor.

Various objects may be moved by the actuator 255. For example, when the content acquisition apparatus 200 is a drone, an object controlled by the actuator 255 may be a propeller, a rotor, or a gimbal which holds a camera so as not to shake. When the content acquisition apparatus 200 is an automobile, an object controlled by the actuator 255 may be a handle or a transmission.

The processor 250 may control an operation of the actuator 255 according to a control signal generated in the content acquisition apparatus 200 or a control signal generated in the content execution apparatus 700 or 800 with reference to the control policy stored in the memory 245.

The radio (or wireless) transceiver 260 may output content CNT output from the processor 250 or content CNT generated under the control of the processor 250 to the first communication network 300. That is, the content acquisition apparatus 200 does not include hardware or software for additional pre-processes, and thus transmits content CNT to the server 400 once the content CNT is generated.

The video data VD collectively refers to signals corresponding to video signals VS or signals generated by processing (for example, encoding or modulating) video signals VS, motion data MD collectively refers to signals corresponding to acceleration ACS and an angular velocity AGS or signals generated by processing (for example, encoding or modulating) acceleration ACS and an angular velocity AGS, and audio data AD collectively refers to signals corresponding to audio signals AS or signals generated by processing (for example, encoding or modulating) audio signals AS.

According to exemplary embodiments, motion data MD may include signals generated by differentiating or integrating each of acceleration ACS and an angular velocity AGS in addition to signals corresponding to acceleration ACS and an angular velocity AGS, and/or signals generated by processing (for example, encoding or modulating) acceleration ACS and an angular velocity AGS. The content CNT may be transmitted in a form of packet.

The content acquisition apparatus 200 may communicate, for example, wirelessly communicate, with the server 400 through the first communication network 300. Each of communication networks 300 and 600 may support or use Bluetooth, Wi-Fi, a cellular system, a wireless LAN, or a satellite communication. The cellular system may be W-CDMA, long term evolution (LTE™), or LTE-advanced (LTE-A), but the present invention is not limited thereto.

The server 400 may receive content CNT transmitted from the content acquisition apparatus 200, and store the content CNT in a database 500 for video on demand (VOD) streaming or transmit the content CNT to at least one of a plurality of content execution apparatuses 700 and 800 for live streaming in accordance with (or based on) a first set signal.

Live streaming, unlike VOD streaming, refers to a technique of reproducing multimedia digital information including video and audio content while encoding the multimedia digital information in real time without downloading it. Live streaming refers to online streaming media simultaneously recorded and broadcast in real time to the viewer. VOD streaming refers to transmitting content stored in the database 500 through the second communication network 600 in accordance with a user's request of the content execution apparatus 700 or 800.

The server 400 which can function as a VOD streaming server and a live streaming server may include a processor 410, a memory 420, a first transceiver 430, a selector 440, and a second transceiver 450.

The processor 410 may control or set operations of the server 400 (for example, content disclosure statuses, content transmission modes (for example, a VOD streaming mode for VOD streaming, a live streaming mode for live streaming, and a mixed mode in which the VOD streaming mode and the live streaming mode are mixed), and authorized (or allowed) users). The processor 410 may control the operation of each component 420, 430, 440, and 450. The processor 410 may be embodied as a CPU, an MCU, a GPU, a GPGPU, or an AP, but the present invention is not limited thereto.

The memory 420 is an exemplary embodiment of a recording medium capable of storing data for the operation of the server 400 and firmware (or programs) executed by the server 400. The memory 420 collectively refers to a volatile memory and a non-volatile memory, and the volatile memory includes a cache memory, a random access memory (RAM), a dynamic RAM (DRAM), and/or a static RAM (SRAM), and the non-volatile memory includes a flash memory.

The first transceiver 430 receives content CNT including video data VD and motion data MD received through the first communication network 300, and transmits the content CNT to the selector 400. The first transceiver 430 may transmit signals output from the processor 410 to the first communication network 300.

The selector 440 may transmit the content CNT including video data VD and motion data MD to any one of the database 500 and the second communication network 600 under control of the processor 410. Even if the selector 440 is shown outside of the processor 410 in FIG. 1, but the selector 440 may be embodied inside of the processor 410 according to exemplary embodiments. In addition, the selector 440 may be embodied as hardware, and may also be embodied as firmware or software which can be executed by the processor 410.

The processor 410 may control the operation of the selector 440 on the basis of a first set signal. The database 500 may receive and store content (CNT=CNT1) for VOD streaming.

Moreover, the database 500 may store data or information exemplarily shown in FIG. 1 in a form of table or look-up table under the control of the processor 410 of the server 400.

For example, the database 500 may store information on users (USER), device IDs (DEVICE) of the content acquisition apparatus 200, content disclosure statuses, content transmission modes, and users (ALL or FUSER1) authorized (or allowed) to access corresponding content. According to exemplary embodiments, the server 400 may store users (USER), device IDs (DEVICE) of the content acquisition apparatus 200, content disclosure statuses, content transmission modes, and users (ALL or FUSER1) authorized to access corresponding content in the memory 420.

The second transceiver 450 may transmit content (CNT=CNT1) for VOD streaming or content (CNT=CNT2) for live streaming to a corresponding content execution apparatus 700 and/or 800 through the second communication network 600 under the control of the processor 410.

A first content execution apparatus (or device) 700 includes a PC 710, a head mounted display (HMD) 720, a motion simulator 730, and a speaker 740. A second content execution apparatus (or device) 800 includes a PC 810, a head mounted display (HMD) 820, a motion simulator 830, and a speaker 840.

Each of the motion simulators 730 and 830 may be a device for a robot, a virtual reality experiencing device, or an exergame. The virtual reality experiencing device may be embodied as a three-dimensional (3D), 4D, 5D, 6D, 7D, 8D, 9D, or XD virtual reality experiencing device. A corresponding PC 710 or 810 may execute content(s) for 3D, 4D, 5D, 6D, 7D, 8D, 9D, or XD.

The PC 710 or 810 separates or extracts (for example, separates at the time of decoding) video data VD and motion data MD from content (CNT=CNT1 or CNT2) including the video data VD and the motion data MD, transmits the video data VD to a corresponding HMD 720 or 830, and transmits the motion data MD to a corresponding motion simulator 730 or 830. The separated video data VD and the separated motion data MD are pieces of data synchronized (synchronized in time) with each other. The PC 710 or 810 collectively refers to a controller which can be called various names to control the content execution apparatus 700 or 800.

According to an exemplary embodiment, the PC 710 or 810 separates or extracts (for example, separates at the time of decoding) video data VD, audio data AD, and motion data MD from content (CNT=CNT1 or CNT2) including the video data VD, the audio data AD, and the motion data MD, transmits the video data VD to a corresponding HMD 720 or 820, transmits the motion data MD to a corresponding motion simulator 730 or 830, and transmits the audio data AD to a corresponding speaker 740 or 840. The separated video data VD, the separated audio data AD, and the separated motion data MD are pieces of data synchronized (synchronized in time) with each other.

The corresponding HMD 720 or 820 may display an image (for example, virtual reality) on the basis of the video data VD. The corresponding motion simulator 730 or 830 may reproduce the motion (for example, roll, pitch, and yaw) of the content acquisition apparatus 200 as it is on the basis of the motion data MD. The corresponding speaker 740 or 840 may output corresponding audio content on the basis of the audio data AD.

The corresponding motion simulator 730 or 830 may reproduce the motion (for example, roll, pitch, and yaw) of the content acquisition apparatus 200 as it is using acceleration ACS and an angular velocity AGS generated by the content acquisition apparatus 200, an integrated value related to at least one of the acceleration CS and the angular velocity AGS, and/or a differentiated value related to at least one of the acceleration ACS and the angular velocity AGS.

Images (for example, 2D images or 3D images) corresponding to images (for example, 2D images or 3D images) photographed by the camera 210 of the content acquisition apparatus 200 may be displayed on the corresponding HMD 720 or 820, and acceleration ACS and an angular velocity AGS measured from sensors 230 and 240 of the content acquisition apparatus 200 may be reflected in the corresponding motion simulator 730 or 830, and audio (or audio content) acquired by the mike 220 may be output through the corresponding speaker 740 or 840.

The corresponding content execution apparatus 700 or 800 can reflect video, audio, and motion acquired by the content acquisition apparatus 200 as it is.

FIG. 2 is an exemplary embodiment of a method of setting a content disclosure status, a content transmission mode, and an authorized user. Firmware (or application programs) executed by the processor 250 of the content acquisition apparatus 200 may provide a user or a smartphone capable of communicating with content acquisition apparatus 200 with a graphical user interface (GUI) 251 shown in FIG. 2.

The GUI 251 includes buttons 253-1 and 253-2 for inputting “content disclosure statuses (content security)”, buttons 255-1 to 255-3 for inputting “content transmission modes”, and input windows 257-1 and 257-2 for inputting at least one “authorized user” who can execute corresponding content(s) through VOC streaming (or a VOD streaming service) or live streaming (or a live streaming service). Identification information for an authorized user may be identification information (for example, a smartphone number, an e-mail address, or the like of the user) capable of allowing to uniquely identify a user using the corresponding content execution apparatus 700 or 800.

Even if the GUI 251 is shown in FIG. 2, a method of generating a first set signal which determines a content transmission mode and a second set signal which determines whether to disclose content may be variously changed. Each set signal may refer to data including a plurality of bits.

Accordingly, the content acquisition apparatus 200 or a smartphone capable of communicating with the content acquisition apparatus 200 may include hardware or software capable of generating a first set signal and a second set signal.

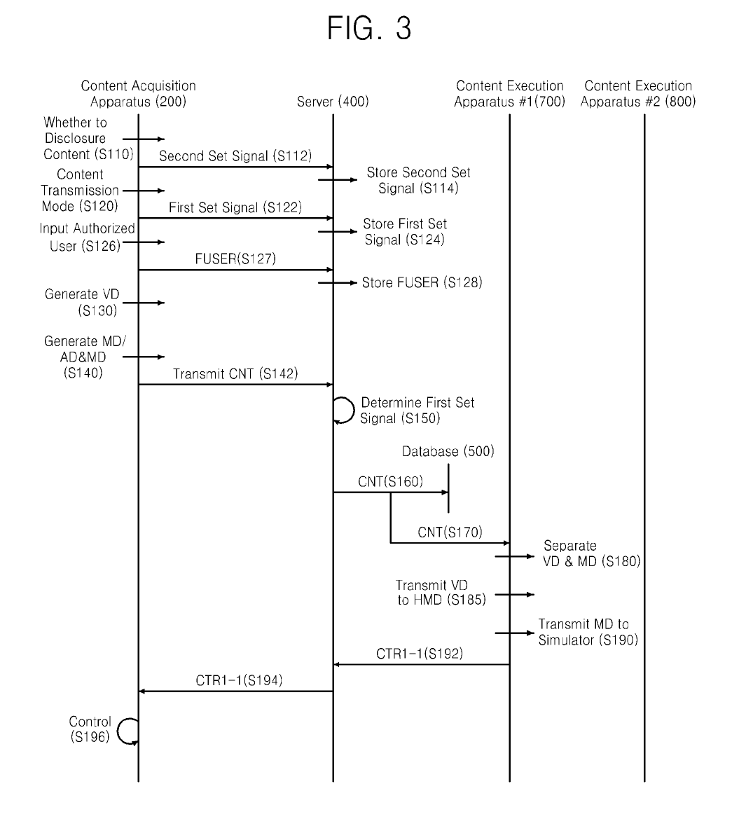

FIG. 3 is a data flow for describing an operation of the data providing service system shown in FIG. 1. Referring to FIGS. 1 to 3, a user of the content acquisition apparatus 200 selects whether to disclose content using one of the buttons 253-1 and 253-2 displayed on a display device of the content acquisition apparatus 200 or a display device of a smart phone capable of communicating with the content acquisition apparatus 200 (S110).

The button 253-1 is a button for selecting a disclosure, public content, or non-security, and, if the button 253-1 is selected, corresponding content may be streamed (for example, VOD streaming or live streaming) to a desired user with no limitation. The button 253-2 is a button for selecting a non-disclosure, private content, or security, and, if the button 253-2 is selected, corresponding content may be streamed (for example, VOD streaming or live streaming) to only a user registered in the server 400 as an authorized (or allowed) user.

As the corresponding button 253-1 or 253-2 is selected, the processor 250 generates a second set signal indicating whether to disclose content, the second set signal is transmitted to the processor 410 through components 260, 300, and 430 (S112), and the processor 410 stores the second set signal in the memory 420 and/or the database 500 (S114). The device ID (DEVICE) of the content acquisition apparatus 200 is transmitted to the processor 410, and the processor 410 stores the device ID (DEVICE) in the memory 420 and/or the database 500.

A user of the content acquisition apparatus 200 selects a content transmission mode using at least one of the buttons 255-1, 255-2, and 255-3 (S120).

The button 255-1 is a button for selecting VOD streaming (or a VOD service), and corresponding content is stored in the database 500 for VOD streaming by the server 400 when the button 255-1 is selected. The button 255-2 is a button for selecting live streaming (or a live service), and corresponding content may be live streamed to a corresponding content execution apparatus 700 and/or 800 by the server 400 when the button 255-2 is selected. That is, the server 400 bypasses the corresponding content. Content for VOD streaming may be referred to as offline content, and content for live streaming may be referred to as online content. Bypassing means that corresponding content is transmitted to the corresponding content execution apparatus 700 and/or 800 in real time or on the fly without being stored in the database 500.

The button 255-3 is a button for selecting VOD streaming (or a VOD service) simultaneously with live streaming (or a live service), and, when the button 255-3 is selected, corresponding content is live streamed to a corresponding content execution apparatus 700 and/or 800 and, at the same time (or in parallel), is stored in the database 500 by the server 400.

As a corresponding button 255-1, 255-2, or 255-3 is selected, the processor 250 generates a first set signal indicating a content transmission mode, the first set signal is transmitted to the processor 410 through the components 260, 300, and 430 (S122), and the processor 410 stores the first set signal in the memory 420 and/or the database 500 (S124).

The user of the content acquisition apparatus 200 inputs an authorized user to each of the input windows 257-1 and 257-2 (S126). When at least one authorized user is input, the processor 250 transmits the input authorized user (or information) FUSER to the processor 410 through the components 260, 300, and 430 (S127), and the processor 410 stores the authorized user (or information) FUSER in the memory 420 and/or the database 500 (S128).

The content acquisition apparatus 200 generates video data VD using a video signal VS photographed (or captured) by the camera 210 (S130), and the content acquisition apparatus 200 generates motion data MD using values ACS and AGS measured by the sensors 230 and 240 (S140). According to an exemplary embodiment, the content acquisition apparatus 200 may further generate not only motion data MD but also audio data AD using audio signals AS acquired from the mike 220 (S140).

The processor 250 of the content acquisition apparatus 200 may generate content (or contents) CNT (S142). The content(s) CNT may include video data VD and motion data MD synchronized with each other in time, or may include video data VD, audio data AD, and motion data MD synchronized with one another in time (S142).

When the server 400 receives the content CNT, the processor 410 of the server 400 searches for the memory 420 or the database 500, reads a first set signal set by a user (USER) of a device ID (DEVICE), and determines whether a content transmission mode is a mode for VOD streaming (a VOD streaming mode), a mode for live streaming (a live streaming mode), or a mixed mode (S150).

It is assumed that a user of the content acquisition apparatus 200 is a first user (USER=USER1), a device ID (DEVICE) of the content acquisition apparatus 200 is DEVICE1, a content transmission mode corresponding to a first set signal is a VOD streaming mode (VOD STREAMING), the content acquisition apparatus 200 generates content (CNT=CNT1), a content disclosure status corresponding to a second set signal is “disclose to all users (ALL).”

In this case, the processor 410 of the server 400 generates a selection signal SEL on the basis of a first set signal indicating VOD streaming, and outputs the selection signal SEL to the selector 440. The selector 440 receives the content (CNT=CNT1) transmitted from the content acquisition apparatus 200 and stores the content (CNT=CNT1) in the database 500 in response to the selection signal SEL (S160).

It is assumed that a user of the content acquisition apparatus 200 is a second user (USER=USER2), a device ID (DEVICE) of the content acquisition apparatus 200 is DEVICE2, a content transmission mode corresponding to a first set signal is a live streaming mode (LIVE STREAMING), an authorized user is a user FUSER1 using the content execution apparatus 700, the content acquisition apparatus 200 generates contents (CNT=CNT2), and a content disclosure status corresponding to a second set signal is “non-disclosure” to all users except for FUSER1.

In this case, the processor 410 of the server 400 generates a selection signal SEL on the basis of a first set signal indicating live streaming, and outputs the selection signal SEL to the selector 440. The selector 440 transmits the content CNT=CNT2 transmitted from the content acquisition apparatus 200 to the second transceiver 450 to transmit (or bypass) it to the content execution apparatus 700 (S170).

Only the content execution apparatus 700 corresponding to the authorized user FUSER1 may receive and execute the content CNT transmitted from the server 400. For example, the PC 710 of the content execution apparatus 700 may compare information on the authorized user FUSER1 included in the content CNT with user information of the content execution apparatus 700, and execute the content CNT because these pieces of information coincide with each other.

However, the content execution apparatus 800 of a user not corresponding to the authorized user FUSER1 may receive the content CNT transmitted from the server 400, but the content execution apparatus 800 may not execute the content CNT. For example, the PC 810 of the content execution apparatus 800 may compare information on the authorized user FUSER1 included in the content CNT with user information of the content execution apparatus 800, and may not execute the content CNT because these pieces of information do not coincide with each other. For example, the server 400 may transmit content CNT to which digital rights management (DRM) is applied to the second communication network 600. As a result, only the content execution apparatus 700 corresponding to the authorized user FUSER1 may execute the content CNT using the DRM.

The PC 710 of the content execution apparatus 700 corresponding to the authorized user FUSER1 may process (for example, demodulate or decode) content CNT=CNT2 including video data VD and motion data MD, and separate or extract the video data VD and the motion data MD from the content CNT=CNT2 (S180).

The PC 710 transmits the video data VD to the HMD 720 (S185), and transmits the motion data MD to the motion simulator 730 (S190). The video data VD transmitted to the HMD 720 and the motion data MD transmitted to the motion simulator 730 are pieces of data synchronized with each other in accordance with time information included in the content CNT=CNT2.

When the content CNT=CNT2 further includes audio data AD, the PC 710 of the content execution apparatus 700 may process (for example, demodulate or decode) the content CNT=CNT2 including the video data VD, audio data AD, and motion data MD, and separate or extract each of the video data VD, the audio data AD, and the motion data MD from the content CNT=CNT2. The PC 710 transmits the video data VD to the HMD 720, transmits the motion data MD to the motion simulator 730, and transmits the audio data AD to the speaker 740. The video data VD transmitted to the HMD 720, the motion data MD transmitted to the motion simulator 730, and the audio data AD transmitted to the speaker 740 are pieces of data synchronized with each other in accordance with time information included in the content CNT=CNT2.

As a user of the content execution apparatus 700 corresponding to the authorized user FUSER1 operates or manipulates the PC 710 or the simulator 730, when the PC 710 or the simulator 730 generates a control signal CTRL1-1 for controlling at least one of components 210, 220, 230, 240, and 255 of the content acquisition apparatus 200, the control signal CTRL1-1 is transmitted to the server 400 through the second communication network 600 (S192), and the control signal CTRL1-1 is transmitted to the content acquisition apparatus 200 through the first communication network 300 (S194).

The processor 250 of the content acquisition apparatus 200 may control at least one of the components 210, 220, 230, 240, and 255 according to the control signal CTRL1-1 (S196).

For example, the camera 210 may change a photographing direction under the control of the processor 250 operating in accordance with the control signal CTRL1-1 (S196). When the content acquisition apparatus 200 is a drone, the actuator 255 may control a propeller or a rotor to control a traveling (or flying) direction and a velocity of the drone under the control of the processor 250 operating in accordance with the control signal CTRL1-1 (S196).

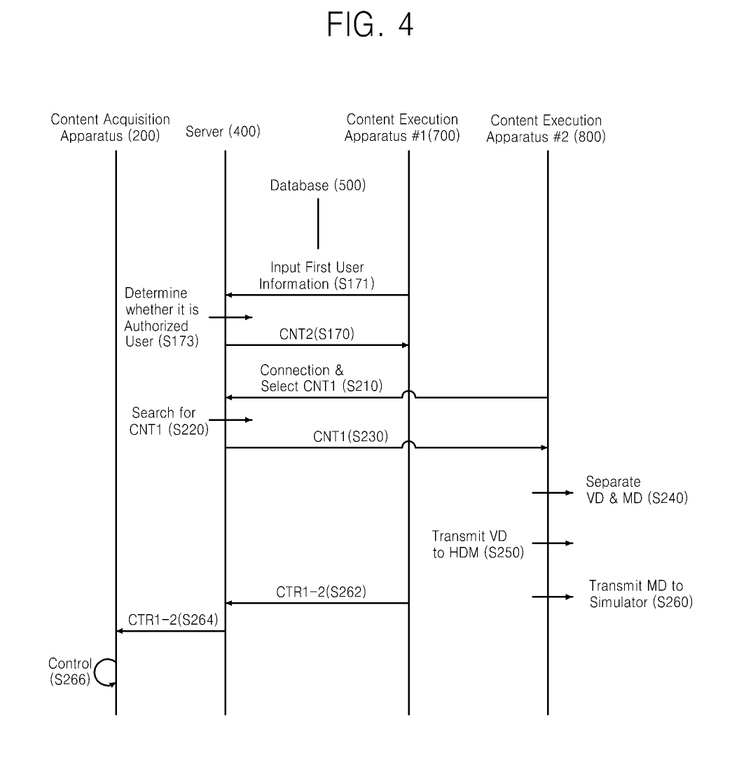

FIG. 4 is a data flow for describing the operation of the data providing service system shown in FIG. 1. Referring to FIGS. 1 to 4, it is assumed that a first user of the first content execution apparatus 700 is a user FUSER1 registered as an authorized user in the server 400, and a second user of a second content execution apparatus 800 is a user not registered as an authorized user in the server 400.

When the first user inputs first user information to the PC 710 of the first content execution apparatus 700 while the first content execution apparatus 700 and the server 400 are connected to each other through the second communication network 600, the PC 710 transmits the first user information to the server 400 (S171). The processor 410 of the server 400 searches or retrieves for the memory 420 or the database 500 on the basis of the first user information, and determines whether the first user is the registered (or allowed) user FUSER1 (S173). When the first user is the registered (or allowed) user FUSER1, the processor 410 of the server 400 transmits the content CNT=CNT2 transmitted from the content acquisition apparatus 200 to the first content execution apparatus 700 in real time or on the fly to live streaming the content CNT=CNT2 (S170).

That is, the server 400 determines with which content execution apparatus to live stream the content CNT=CNT2 with reference to a content disclosure status, a content transmission mode, and an authorized user stored in the memory 420 or the database 500, and transmits the content CNT=CNT2 in real time or on the fly to a determined content execution apparatus according to a result of the determination (S170).

When a second user inputs second user information to the PC 810 of the second content execution apparatus 800 while the second content execution apparatus 800 and the server 400 are connected to each other through the second communication network 600, the PC 810 transmits the second user information to the server 400.

When the second user is authenticated as a user who can receive VOD streaming, the second user searches for content from the database which can be accessed by the server 400 using the PC 810, and selects the content CNT=CNT1 to be VOD streamed (S210). The processor 410 of the server 40 searches for the content CNT=CNT1 from the database 500 (S220), and streams the content CNT=CNT1 (S230).

The PC 810 of the content execution apparatus 800 may process (for example, demodulate or decode) the content CNT=CNT1 including video data VD and motion data MD, and separate or extract the video data VD and the motion data MD from the content CNT=CNT1 (S240).

The PC 810 transmits the video data VD to the HMD 820 (S250), and transmits the motion data MD to the motion simulator 830 (S260). The video data VD transmitted to the HMD 820 and the motion data MD transmitted to the motion simulator 830 are pieces of data synchronized with each other in accordance with time information included in the content CNT=CNT1.

When the content CNT=CNT1 further includes audio data AD, the PC 810 of the content execution apparatus 800 may process, for example, demodulate or decode, the content CNT=CNT1 including the video data VD, the audio data AD, and the motion data MD, and separate or extract each of the video data VD, the audio data AD, and the motion data MD from the content CNT=CNT1.

The PC 810 transits the video data VD to the HMD 820, transmits the motion data MD to the motion simulator 830, and transmits the audio data AD to the speaker 840. The video data VD transmitted to the HMD 820, the motion data MD transmitted to the motion simulator 830, and the audio data AD transmitted to the speaker 840 are pieces of data synchronized with each other in accordance with time information included in the content CNT=CNT1.

As a user of the content execution apparatus 700 corresponding to the authorized user FUSER1 operates or manipulates the PC 710 or the simulator 730, when the PC 710 or the simulator 730 generates a control signal CTRL1-2 for controlling at least one of the components 210, 220, 230, 240, and 255 of the content acquisition apparatus 200, the control signal CTRL1-2 is transmitted to the server 400 through the second communication network 600 (S262), and the control signal CTRL1-2 is transmitted to the content acquisition apparatus 200 through the first communication network 300 (S264).

The processor 250 of the content acquisition apparatus 200 may control at least one of the components 210, 220, 230, 240, and 255 according to the control signal CTRL1-2 (S266).

For example, the camera 210 may change a photographing direction under the control of the processor 250 operating in accordance with the control signal CTRL1-2 (S266). When the content acquisition apparatus 200 is a drone, the actuator 255 may control a propeller or a rotor to control the traveling (or flying) direction and the velocity of the drone under the control of the processor 250 operating in accordance with the control signal CTRL1-2 (S266).

Referring to FIGS. 3 and 4, when a control signal generated in the content acquisition apparatus 200 according to an operation (or manipulation) of a user of the content acquisition apparatus 200 and a control signal CTRL1-1 or CTRL1-2 transmitted from the content execution apparatus 700 are in conflict with each other. For example, when a user's intention of the content acquisition apparatus 200 to move (or rotate) the content acquisition apparatus 200 to the left conflicts with a user's intention of the content execution apparatus 700 to move (or rotate) the content acquisition apparatus 200 to the right), the processor 250 may determine which control signal to process first with reference to the control policy stored in the memory 245.

For example, when the control policy gives priority to control signals in accordance with the user's intention of the content acquisition apparatus 200, the processor 250 may control at least one of the components 210, 220, 230, 240, and 255 according to a control signal in accordance with the user's intention of the content acquisition apparatus 200.

However, when the control policy gives priority to the control signal CTRL1-1 or CTRL1-2 transmitted from the content execution apparatus 700, the processor 250 may control at least one of the components 210, 220, 230, 240, and 255 according to the control signal CTRL1-1 or CTRL1-2.

The device 900 not including a simulator, for example, a smart phone, may receive video data VD and/or audio data AD through the second communication network 600 which can communicate with the server 400, and reproduce the video data VD and/or the audio data AD.

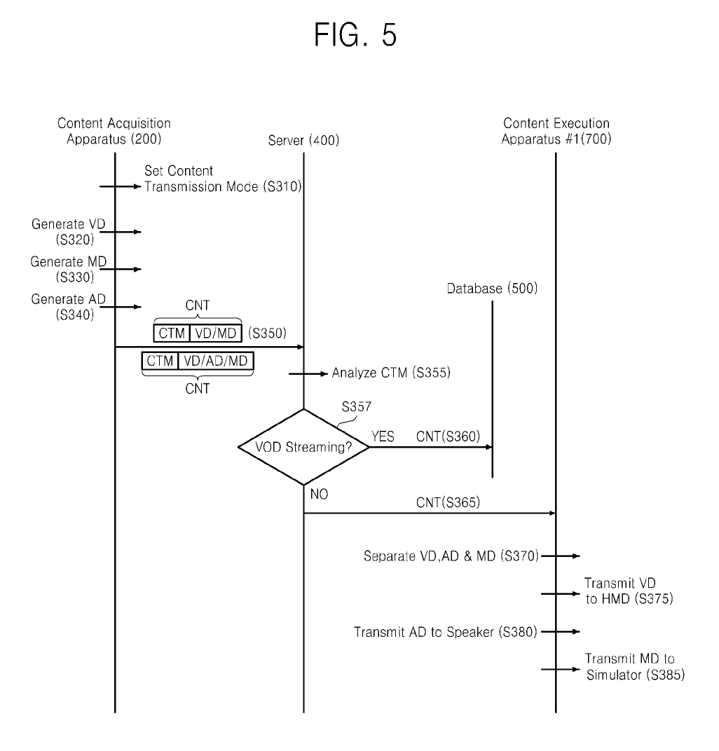

FIG. 5 is a data flow for describing an operation of the data providing service system shown in FIG. 1. Referring to FIGS. 1, 2, and 5, a user of the content acquisition apparatus 200 sets a content transmission mode (S310). The set content transmission mode is one of a VOD streaming mode, a live streaming mode, and a mixed mode.

The content acquisition apparatus 200 generates video data VD using video signals VS photographed or captured by the camera 210 (S320), and the content acquisition apparatus 200 generates motion data MD using values or information ACS and AGS measured by the sensors 230 and 240 (S330). According to an exemplary embodiment, the content acquisition apparatus 20 may further generate audio data AD using audio signals AS acquired from the mike 220 in addition to the motion data MD (S340).

The processor 250 of the content acquisition apparatus 200 may generate content (or contents) CNT including mode information CTM on a content transmission mode set by a user, and transmit the content CNT to the server 400 (S350). The content CNT includes video data VD and motion data MD synchronized with each other in time or includes video data VD, audio data AD, and motion data MD synchronized with one another in time.

When the content CNT is received by the server 400, the processor 410 of the server 400 interprets or analyzes mode information CTM (S355). When the mode information CTM indicates VOD streaming (YES in S357), the server 400 receives the content CNT transmitted from the content acquisition apparatus 200 and stores it in the database 500 (S360).

When the mode information CTM indicates live streaming (NO in S357), the server 400 bypasses the content CNT transmitted from the content acquisition apparatus 200, that is, without storing the content in the database 500, and transmits it to the second communication network 600 (S365). That is, the server 400 live streams the content CNT transmitted from the content acquisition apparatus 200 to a corresponding content execution apparatus 700 (S365).

When the mode information CTM indicates a mixed mode including live streaming and VOD streaming (NO in S357), the server 400 transmits the content CNT transmitted from the content acquisition apparatus 200 to the second communication network 600 in parallel while storing it in the database 500.

When the content CNT further includes audio data AD, the PC 710 of the content execution apparatus 700 may receive and process, for example, demodulate or decode, the content CNT=CNT2 including video data VD, audio data AD, and motion data MD, and separate or extract each of the video data VD, the audio data AD, and the motion data MD from the content CNT (S370).

The PC 710 transmits the video data VD to the HMD 720 (S375), transmits the audio data AD to the speaker 740 (S380), and transmits the motion data MD to the motion simulator 730 (S385). The video data VD transmitted to the HMD 720, the motion data MD transmitted to the motion simulator 730, and the audio data AD transmitted to the speaker 740 are pieces of data synchronized with each other in accordance with time information included in the content CNT.

The device 900 may be embodied as a smart phone, a tablet PC, or a mobile internet device (MID). When a user of the device 900 is a person (for example, a guardian, friend, or acquaintance) related to the first user of the first content execution apparatus 700, when the user of the device 900 registers a unique number (for example, a telephone number or IP address) of the device 900 in the server 400, the server 400 may transmit video data VD and/or audio data AD included in the content CNT=CNT2 to the device 900 while live streaming the content CNT=CNT2 to the first content execution apparatus 700. As a result, the user of the device 900 who cannot use the motion simulator 730 may experience the video data VD and/or audio data AD in the content CNT=CNT2 which the first user of the first content execution apparatus 700 experiences.

Moreover, when the user of the device 900 is a person (for example, a guardian, friend, or acquaintance) related to the second user of the second content execution apparatus 800, when the user of the device 900 registers a unique number (for example, a telephone number or IP address) of the device 900 in the server 400, the server 400 may transmit video data VD and/or audio data AD included in the content CNT=CNT1 to the device 900 while VOD streaming the content CNT=CNT1 to the second content execution apparatus 800. As a result, the user of the device 900 who cannot use the motion simulator 830 may experience the video data VD and/or audio data AD in the content CNT=CNT1 which the second user of the second content execution apparatus 800 experiences.

In the method according to the embodiments of the present invention, content (or contents) generated by a content acquisition apparatus can be stored in a database for VOD streaming or can be live streamed to a content execution apparatus in accordance with settings of a user. Therefore, a user of a content execution apparatus can enjoy realistic content.

In the method according to the embodiments of the present invention, a user of the content acquisition apparatus and/or a user of the content execution apparatus can control or adjust at least one of components included in the content acquisition apparatus.

What is claimed is:

1. A method for providing a content service using a content acquisition apparatus, a server, and a content execution apparatus, the method comprising:
generating video data using a camera of the content acquisition apparatus, generating motion data by measuring an angular velocity and acceleration of the content acquisition apparatus using sensors of the content acquisition apparatus, and generating content by synchronizing the video data with the motion data;
reading, by the server, a first set signal from a memory;
receiving, by the server, the content transmitted from the content acquisition apparatus and storing the content in a database when the first set signal indicates VOD streaming, and receiving, by the server, the content transmitted from the content acquisition apparatus and live streaming the content to the content execution apparatus when the first set signal indicates live streaming; and
separating, by the content execution apparatus, the video data and the motion data from the content to be live streamed, transmitting the video data to a head mounted device (HMD), and transmitting the motion data to a motion simulator so that the motion simulator reproduces a motion corresponding to the motion data.

2. The method of claim 1, further comprising:
generating, by the content acquisition apparatus, the first set signal and transmitting the first set signal to the server; and
storing, by the server, the first set signal in the memory.

3. The method of claim 1, further comprising:
generating audio data using a mike of the content acquisition apparatus, and generating the content by synchronizing the video data, the audio data, and the motion data with one another; and
separating, by the content execution apparatus, the video data, the audio data, and the motion data from the content to be live streamed by the server, transmitting the video data to the HMD, transmitting the audio data to a speaker, and transmitting the motion data to the motion simulator.

4. The method of claim 3,
receiving, by the server, the content including the video data, the audio data, and the motion data from the content acquisition apparatus; and
transmitting, by the server, the video data and the audio data included in the content transmitted from the content acquisition apparatus to a smart phone while live streaming the content to the content execution apparatus after receiving the content.

5. The method of claim 1, further comprising:
receiving, by the server, a control signal from the content execution apparatus and transmitting the control signal to the content acquisition apparatus; and
controlling, by the content acquisition apparatus, an actuator included in the content acquisition apparatus on the basis of the control signal.

6. The method of claim 5, further comprising:
determining, by the content acquisition apparatus, which control signal to execute first between a control signal generated according to a user's input of the content acquisition apparatus and the control signal transmitted from the content execution apparatus in accordance with a control policy.

7. A method for providing a content service using a content acquisition apparatus, a server, and a content execution apparatus, the method comprising:
setting a content transmission mode using the content acquisition apparatus;
generating video data using a camera of the content acquisition apparatus, generating motion data by measuring an angular velocity and acceleration of the content acquisition apparatus using sensors of the content acquisition apparatus, and generating content which includes mode information including the content transmission mode, the video data, and the motion data;
receiving, by the server, the content transmitted from the content acquisition apparatus;
determining, by the server, the mode information;
receiving and storing, by the server, the content in a database when the mode information indicates VOD streaming, and bypassing and live streaming, by the server, the content to the content execution apparatus when the mode information indicates live streaming; and
separating, by the content execution apparatus, the video data and the motion data from the content to be live streamed, transmitting the video data to a head mounted device (HMD), and transmitting the motion data to a motion simulator so that the motion simulator reproduces a motion corresponding to the motion data.

8. The method of claim 7, further comprising:
receiving, by the server, a control signal from the content execution apparatus, and transmitting the control signal to the content acquisition apparatus; and
controlling, by the content acquisition apparatus, an actuator included in the content acquisition apparatus on the basis of the control signal.

9. The method of claim 8, further comprising:
determining, by the content acquisition apparatus, which control signal to execute first between a control signal generated according to a user's input of the content acquisition apparatus and the control signal transmitted from the content execution apparatus in accordance with a control policy.

10. A content providing service system comprising:
a content acquisition apparatus including a camera, sensors, and an actuator;
a content execution apparatus including a head mounted device (HMD) and a motion simulator; and
a server configured to transmit or receive data to or from the content acquisition apparatus through a first communication network, and configured to transmit or receive data to or from the content execution apparatus through a second communication network,
wherein the content acquisition apparatus configured to generate video data using the camera, generate motion data by measuring an angular velocity and acceleration of the content acquisition apparatus using the sensors, generate content by synchronizing the video data with the motion data, and transmit the content to the server through the first communication network,
wherein the server further configured to read a set signal from a memory, if the set signal indicates VOD streaming, receive the content transmitted from the content acquisition apparatus to store the content in a database, and if the set signal indicates live streaming, receive the content transmitted from the content acquisition apparatus to live stream the content to the content execution apparatus, and
wherein the content execution apparatus is further configured to separate the video data and the motion data from the content to be live streamed, transmit the video data to the HMD, and transmit the motion data to a motion simulator so that the motion simulator reproduces a motion corresponding to the motion data.
